(19) United States
(12) Patent Application Publication
(10) Pub. No.: US 2026/0111043 A1
(43) Pub. Date: Apr. 23, 2026

(54) SYSTEMS AND METHODS FOR SPLIT PROCESSING-BASED SMART TRANSPORT VEHICLE CONTROL

(71) Applicants: Hyundai Motor Company, Seoul (KR); Kia Corporation, Seoul (KR)

(72) Inventors: Kyung Dong Park, Hwaseong (KR); Man ki Lee, Hwaseong (KR)

(21) Appl. No.: 19/169,145

(22) Filed: Apr. 3, 2025

(30) Foreign Application Priority Data
Oct. 22, 2024 (KR) 10-2024-0144812

(51) Int. Cl. G05D 1/698; G05D 1/693; G05D 105/28; G05D 107/70

(52) U.S. Cl. CPC G05D 1/6987; G05D 1/693; G05D 2105/28; G05D 2107/70

(57) ABSTRACT

A split processing-based smart transport vehicle control device according to an exemplary embodiment comprises smart transport vehicles configured to transport objects in an unmanned manner in an industrial system, and control servers configured to control the smart transport vehicles. The control servers may comprise a master control server configured to control a first smart transport vehicle and one or more slave control servers configured to control one or more second smart transport vehicles, and the master control server may be configured to collectively control traffic between the first smart transport vehicle and the one or more second smart transport vehicles.

### CROSS-REFERENCE TO RELATED APPLICATION

This application claims, under 35 U.S.C. § 119(a), the benefit of Korean Patent Application No. 10-2024-0144812 filed in the Korean Intellectual Property Office on Oct. 22, 2024, the disclosure of which is incorporated herein by reference in its entirety.

### BACKGROUND

### Technical Field

The present disclosure relates to systems and methods for split processing-based smart transport vehicle control and, more particularly, to systems and methods for performing split processing-based smart transport vehicle control for avoiding a collision between unmanned transport vehicles through traffic management using a master/slave scheme.

### Background

Typically, in a vehicle manufacturing plant based on a smart factory, an automated line process is modularized to assemble various parts, and logistics robots are used for the flexible transport of parts (including products, etc.) for each process. In an automated process, interruption in supplying parts during work causes a stop of the line and affects productivity. Therefore, it is very important to supply parts to the right places at the right times by smoothly operating logistics robots.

Meanwhile, the logistics robots are deployed for work. The logistics robots include, e.g., automated guided vehicles (AGVs) and autonomous mobile robots (AMRs) whose manufacturers are different, and are operated through separate local systems depending on manufacturers and models.

However, when the AGVs and AMRs are simultaneously operated in a limited space within a factory, a traffic section inevitably exists because transport routes overlap, and AGVs and AMRs of different manufacturers (models) or purposes are not capable of communicating with each other in the traffic section, making traffic management difficult.

### SUMMARY

The present disclosure attempts to provide a split processing-based smart transport vehicle control device and method capable of enabling a master to collectively control traffic based on data from slaves when the traffic occurs due to a communication time delay between automated guided vehicles (AGVs)/autonomous mobile robots (AMRs) and an AGV/AMR control system (ACS).

An exemplary embodiment of the present disclosure provides a split processing-based smart transport vehicle control device including: smart transport vehicles configured to transport objects in an unmanned manner in an industrial system; and control servers configured to control the smart transport vehicles, wherein the control servers include: a master control server configured to control a first smart transport vehicle; and slave control servers configured to control second smart transport vehicles, and the master control server collectively controls traffic between the first smart transport vehicle and the second smart transport vehicles.

The slave control servers may be configured to monitor the second smart transport vehicles assigned thereto, respectively, and transmit current locations, driving speeds, and driving routes of the second smart transport vehicles to the master control server.

The master control server may be configured to receive process status information including a process speed from a process line, and set a traffic section based on the received process status information.

The master control server may comprise a traffic management unit configured to detect traffic data between the first smart transport vehicle and the second smart transport vehicles based on the process status information, the traffic section, and the current locations, driving speeds, and driving routes of the second smart transport vehicles.

The traffic management unit may be configured to detect priorities between the first smart transport vehicle and the second smart transport vehicles based on the detected traffic data, and control the smart transport vehicles based on the priorities.

The traffic management unit may be configured to request the first smart transport vehicle or one of the second smart transport vehicles to accelerate and request another one of the second smart transport vehicles to decelerate based on the priorities.

The traffic management unit may be configured to command each of the second smart transport vehicles to stop, slow down, accelerate, or cancel a task, based on the current locations, driving speeds, and driving routes of the second smart transport vehicles, to avoid a collision between the second smart transport vehicles.

The traffic management unit may be configured to collectively command the second smart transport vehicles to operate in a power saving mode or wake up from the power saving mode.

The master control server may be connected to a plurality of databases of the plurality of slave control servers to acquire data about the second smart transport vehicles in a black box manner from the plurality of databases.

The smart transport vehicles may comprise automated guided vehicles (AGVs) or autonomous mobile robots (AMRs), and the control servers may comprise AGV/AMR control systems (ACSs).

Another exemplary embodiment of the present disclosure provides a split processing-based smart transport vehicle control method is provided. The method may comprise: receiving, by a master control server configured to control a first smart transport vehicle, process status information from a process line; setting, by the master control server, a traffic section based on the process status information; receiving, by the master control server, current locations, driving speeds, and driving routes of second smart transport vehicles controlled by slave control servers; detecting, by the master control server, traffic data based on the process status information and the current locations, driving speeds, and driving routes of the second smart transport vehicles; and collectively controlling, by the master control server, traffic between the first smart transport vehicle and the second smart transport vehicles based on the traffic data.

The split processing-based smart transport vehicle control method may comprise confirming, by the master control server, whether the slave control servers are in an active state.

The split processing-based smart transport vehicle control method may comprise monitoring, by the slave control servers, the second smart transport vehicles assigned thereto, respectively, and transmitting the current locations, driving speeds, and driving routes of the second smart transport vehicles to the master control server.

The collectively controlling of the traffic between the first smart transport vehicle and the second smart transport vehicles based on the traffic data by the master control server may comprise detecting, by the master control server, priorities between the first smart transport vehicle and the second smart transport vehicles based on the traffic data, and controlling the first smart transport vehicle and the second smart transport vehicles based on the priorities.

The controlling of the first smart transport vehicle and the second smart transport vehicles based on the priorities by the master control server may comprise requesting the first smart transport vehicle or one of the second smart transport vehicles to accelerate and requesting another one of the second smart transport vehicles to decelerate based on the priorities.

The split processing-based smart transport vehicle control method may comprise commanding, by the master control server, each of the second smart transport vehicles to stop, slow down, accelerate, or cancel a task, based on the current locations, driving speeds, and driving routes of the second smart transport vehicles, to avoid a collision between the second smart transport vehicles.

The collectively controlling of the traffic between the first smart transport vehicle and the second smart transport vehicles based on the traffic data by the master control server may comprise collectively commanding, by the master control server, the second smart transport vehicles to operate in a power saving mode or wake up from the power saving mode.

The split processing-based smart transport vehicle control method may comprise connecting the master control server to a plurality of databases of the plurality of slave control servers, and acquiring data about the second smart transport vehicles in a black box manner from the plurality of databases.

The split processing-based smart transport vehicle control method may comprise excluding a slave control server of which the active state is not confirmed, among the slave control servers, from a traffic management target.

The first and second smart transport vehicles may comprise automated guided vehicles (AGVs) or autonomous mobile robots (AMRs), and the master and slave control servers may include AGV/AMR control systems (ACSs).

The split processing-based smart transport vehicle control device and method according to an exemplary embodiment of the present disclosure may be capable of relieving traffic generated in unmanned logistics operation and improving productivity by enabling the master to control the traffic based on data from the slaves.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 illustrates an example split processing-based smart transport vehicle control system, according to an exemplary embodiment of the present disclosure;

FIG. 2 is a block diagram of a split processing-based smart transport vehicle control device according to an exemplary embodiment of the present disclosure;

FIG. 3 is a flowchart of a split processing-based smart transport vehicle control method, according to an exemplary embodiment of the present disclosure;

FIG. 4 is a signal flow diagram of the split processing-based smart transport vehicle control method, according to an exemplary embodiment of the present disclosure;

FIG. 5 is a signal flow diagram of the split processing-based smart transport vehicle control method, according to an exemplary embodiment of the present disclosure;

FIG. 6 is a diagram for explaining the split processing-based smart transport vehicle control device, according to an exemplary embodiment of the present disclosure; and

FIG. 7 is a diagram for explaining a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, exemplary embodiments of the present disclosure will be described with reference to the drawings.

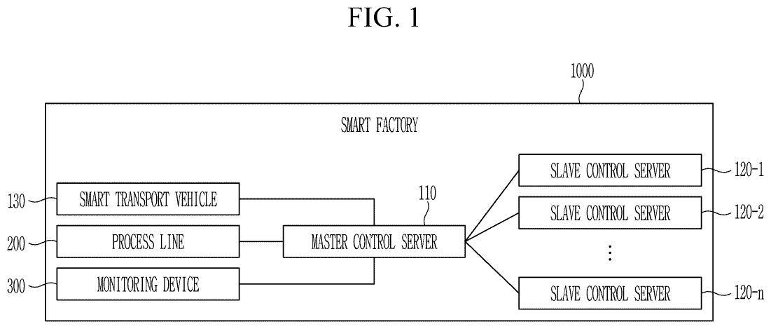

FIG. 1 schematically illustrates a split processing-based smart transport vehicle control system, according to an exemplary embodiment of the present disclosure.

The split processing-based smart transport vehicle control system may be configured to be operated in a smart factory 1000.

The smart factory 1000 may be an intelligent production factory configured to improve productivity, quality, and customer satisfaction by applying information and communication technology (ICT) combined with digital automation solutions to production processes such as design, development, manufacturing, and distribution. The smart factory 1000 may be configured to collect process data in real time, analyze the process data, and control itself by installing the Internet of Things (IoT) in the facilities and machines inside the factory.

Referring now to FIG. 1, the smart factory 1000 may comprise a master control server 110, one or more slave control servers 120, one or more smart transport vehicles 130, a process line 200, one or more monitoring devices 300, and/or other suitable components.

The control servers 110 and 120 may comprise servers configured to monitor and control one or more manufacturing processes or industrial processes in real time. The control servers 110 and 120 may comprise servers that transmit commands and manage traffic between a plurality of unmanned smart transport vehicles 130 when the smart transport vehicles 130 are operated within one space.

According to an exemplary embodiment, the control servers 110 and 120 may be split into a master control server 110 and one or more slave control servers 120. The master control server 110 may be configured to regulate and control a plurality of slave control servers 120-1, 120-2, . . . and 120-n.

The smart transport vehicle 130 may comprise an unmanned smart logistics transport vehicle. That is, the smart transport vehicle 130 may refer to a robot or a vehicle that automatically transports goods in various industrial environments such as logistics warehouses, factories, and hospitals. The smart transport vehicle 130 may be configured to move according to a route plan or autonomously, and perform a function of moving goods to a designated location without human intervention. For example, the smart transport vehicle 130 may comprise an automated guided vehicle (AGV) and/or an autonomous mobile robot (AMR).

The process line 200 may refer to a flow of a series of tasks in which steps are sequentially connected to one another in a process of producing a product. The process line 200 may comprise a process line control system such as a process programmable logic controller (PLC) and/or a supervisory control and data acquisition (SCADA) system. The process line 200 may comprise a concept including various kinds of process equipment including a work station, a conveyor belt, automation equipment, and a control system required for a main process. The process line 200 may be configured to provide information related to various process lines, including process status, movement status, main flow speed, production sequence, and component supply sequence.

The monitoring device 300 may comprise equipment or a system configured to monitor and manage the work status in real time in a process. For example, the monitoring device 300 may comprise a closed-circuit television (CCTV).

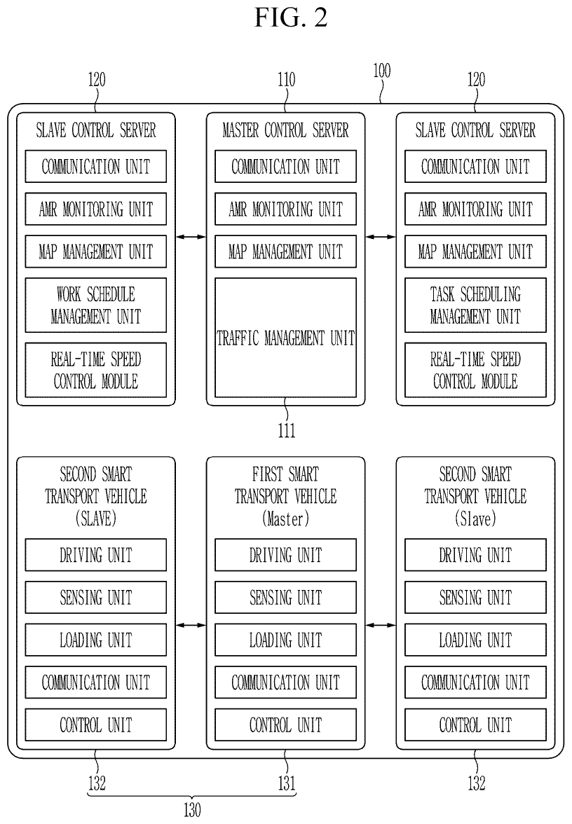

Referring now to FIG. 2, a block diagram of a split processing-based smart transport vehicle control device is illustratively depicted, according to an exemplary embodiment of the present disclosure.

The split processing-based smart transport vehicle control device 100 may be configured to control the master control server 110, the one or more slave control servers 120, and the smart transport vehicle 130 arranged in the smart factory 1000 of FIG. 1, and manage traffic caused by a communication delay occurring therebetween.

Referring to FIG. 2, the split processing-based smart transport vehicle control device 100 may comprise a master control server 110, one or more slave control servers 120, and one or more smart transport vehicles 130.

The control servers 110 and 120 may be configured to perform integrated control with respect to a plurality of smart transport vehicles. That is, the control servers 110 and 120 may e configured to communicate with the smart transport vehicles 130 and the process line 200 (see, e.g., FIG. 1) to generate and transmit commands. The control servers 110 and 120 may comprise AGV/AMR control systems (ACSs) and/or other suitable control systems. The control servers 110 and 120 may be provided in a plural number.

The split processing-based smart transport vehicle control device 100 may be configured to split the plurality of control servers 110 and 120 into the master control server 110 and the one or more slave control servers 120. The split processing-based smart transport vehicle control device 100 may be configured to transmit a stop, acceleration, or deceleration command to the smart transport vehicle 130 in a moving state based on a virtual area or zone using the plurality of control servers 110 and 120.

The split processing-based smart transport vehicle control device 100 may be configured to designate the plurality of control servers 110 and 120 while separating them into the master control server 110 and the one or more slave control servers 120 to manage traffic that occurs according to a speed delay of a wired/wireless network. That is, the split processing-based smart transport vehicle control device 100 may be configured to control the control servers 110 and 120 while separating them into the master control server 110 and the one or more slave control servers 120 for traffic management between the smart transport vehicles 130 aggravated by a communication delay that occurs between the plurality of control servers.

According to an exemplary embodiment, the traffic management may be a key function that enables the smart transport vehicles 130 to move safely and efficiently in industrial environments such as factories and warehouses. The smart transport vehicle 130 may comprise an unmanned transport vehicle, comprising a system designed to automatically transport goods or move along a specific route. When a plurality of smart transport vehicles 130 are operated simultaneously, traffic management is essential to avoid collisions and move them along optimal routes because their routes may overlap each other.

The split processing-based smart transport vehicle control device 100 may be configured to process and share traffic data between a first smart transport vehicle 131 controlled by the master control server 110 and a plurality of second smart transport vehicles 132 controlled by the plurality of slave control servers 120.

According to an exemplary embodiment, the traffic data may comprise data used for traffic management. For example, the traffic data may comprise location data, speed data, status data, obstacle information, intersection information, and priority information inside an intersection of the smart transport vehicles 130, which are necessary for traffic management such as route optimization, collision avoidance, intersection control, and task scheduling management of the smart transport vehicles 130.

The split processing-based smart transport vehicle control device 100 may be configured to designate the master control server 110 among the plurality of slave control servers 120. One or more master control servers 110 may be designated, and a target master control server 110 may be designated separately for each of the plurality of slave control servers 120.

The split processing-based smart transport vehicle control device 100 may be configured to collectively perform traffic management through the master control server 110 based on data from the slave control servers 120. The master control server 110 may be configured to provide a location, a state, a driving speed, and a driving route of the first smart transport vehicle 131 assigned thereto. The master control server 110 may be configured to collectively manage traffic between the first smart transport vehicle 131 and the second smart transport vehicles 132. The master control server 110 may be configured to collectively provide a command to the slave control servers 120 to cancel, stop, or start a task. The master control server 110 may be configured to receive process status information comprising a process speed from the process line, and set a traffic section based on the received process status information. The master control server 110 may comprise a communication unit, an AMR monitoring unit, a map management unit, and a traffic management unit 111.

The communication unit 111 may comprise a section responsible for data exchange between the master control server 110, the smart transport vehicle 130, and/or other devices. The communication unit 111 may be responsible for real-time data exchange between the master control server 110 and the first smart transport vehicle 131. The communication unit 111 may be configured to transmit a current location, status, and route information of the first smart transport vehicle 131, and receive a command from the master control server 110.

The AMR monitoring unit may comprise a section that is configured to monitor and manages real-time status and operation information of the AMR. The AMR monitoring unit may be configured to monitor a current location, a battery state, a speed, and work status for each AMR in real time. When any problem occurs with the AMR (e.g. collision, low battery, or route deviation), the AMR monitoring unit may be configure to immediately detect the problem and notify an administrator of the problem. The AMR monitoring unit may be configured to track, in real time, what task the AMR is performing and what task the AMR has completed. The AMR monitoring unit may comprise an AGV monitoring unit.

The map management unit may comprise a section that is configured to manage the route and environment in which the first smart transport vehicle 131 moves, and provide an optimized map. The map management unit may be configured to create a map indicating a route along which the first smart transport vehicle 131 is allowed to move, and modify the map according to an environmental change. The map management unit may be configured to analyze the work status of the first smart transport vehicle 131 and the traffic flow and optimize the route, in real time, to support efficient work. The map management unit may be configured to reflect work zones, restricted areas, obstacle locations, etc. on the map, and set a route to enable the first smart transport vehicle 131 to move safely.

The traffic management unit 111 may be configured to detect traffic data between the first smart transport vehicle 131 and the one or more second smart transport vehicles 132 based on the process status information, the traffic section, and the current locations, driving speeds, and driving routes of the second smart transport vehicles 132. The traffic management unit 111 may be configured to detect priorities between the first smart transport vehicle 131 and the one or more second smart transport vehicles 132 based on the detected traffic data, and control the smart transport vehicles based on the priorities. Based on the priorities, the traffic management unit 111 may be configured to request the first smart transport vehicle 131 or one of the second smart transport vehicles 132 to accelerate and request another one of the second smart transport vehicles to decelerate.

The traffic management unit 111 may be configured to command each of the second smart transport vehicles 132 to stop, slow down, accelerate, or cancel a task, based on the current locations, driving speeds, and driving routes of the second smart transport vehicles 132, to avoid a collision between the second smart transport vehicles 132. The traffic management unit 111 may be configured to collectively command the one or more second smart transport vehicles 132 to operate in a power saving mode or wake up from the power saving mode.

The master control server 110 may be configured to be connected to a plurality of databases of the plurality of slave control servers to acquire data about the one or more second smart transport vehicles 132 in a black box manner from the plurality of databases.

The one or more slave control servers 120 may be configured to monitor and control the one or more second smart transport vehicles 132 assigned thereto, respectively, and provide current locations, driving speeds, and driving routes of the second smart transport vehicles to the master control server 110. The slave control server 120 may comprise a communication unit 111, an AMR monitoring unit, and a map management unit required to control the one or more second smart transport vehicles 132. According to an exemplary embodiment, for an example of the communication unit 111, the AMR monitoring unit, and the map management unit of the slave control server 120, refer to the description of the master control server 110.

The slave control server 120 may comprise a task scheduling management unit and a real-time speed control module. The task scheduling management unit may comprise a section that is configured to efficiently plan and manage tasks assigned to each of the second smart transport vehicles 132, when a plurality of second smart transport vehicles 132 are operated simultaneously. The task scheduling management unit may be configured to set one or more priorities between the tasks based on degrees of importance and urgency of the tasks and a current state of each of the second smart transport vehicles 132. This enables each second smart transport vehicle 132 (or a group of second smart transport vehicles 132) to process the most important task first and minimize inefficient stand-by.

The task scheduling management unit may be configured to automatically assign appropriate tasks, considering the current location and availability of each of the second smart transport vehicles 132. For example, the task scheduling management unit may be configured to assign tasks to a nearby second smart transport vehicle 132 to reduce movement time and increase efficiency.

When any environmental change or unexpected situation (such as, e.g., a failure of the AGV or an obstacle in the route) occurs during a task, the task scheduling management unit may be configured to readjust the task scheduling in real time, thereby ensuring the flexibility of the system. The task scheduling management unit may be configured to track the progress of the task that is being performed by a second smart transport vehicle 132, in real time, and immediately assign a next task after the task is completed.

The real-time speed control module may comprise a section that is configured to adjust the speed, in real time, such that a second smart transport vehicle 132 may safely move along the route while maintaining the optimal speed. The real-time speed control module may be configured to control the second smart transport vehicle 132 to slow down or stop when approaching another second smart transport vehicle 132 or an obstacle, thereby avoiding a collision.

The real-time speed control module may be configured to adjust the speed to maintain a safe distance between the second smart transport vehicles 132. The real-time speed control module may be configured to adjust the speed such that the second smart transport vehicle 132 slows down or stands by when approaching an intersection or a narrow path, thereby relieving traffic congestion and ensuring safe passage.

The real-time speed control module maybe configured to automatically adjust the speed of the second smart transport vehicle 132 in accordance with the characteristic (e.g. straight section or curved section) of the route. That is, the real-time speed control module may be configured to increase the speed of the second smart transport vehicle 132 in a straight section, and reduce the speed of the second smart transport vehicle 132 in a curve or in a dangerous section. The real-time speed control module may be configured to minimize energy consumption of the second smart transport vehicle 132 and maximizes battery lifespan by reducing unnecessary acceleration and deceleration.

The smart transport vehicles 130 may comprise one or more robots or vehicles that are transport objects in an unmanned manner in an industrial system. The smart transport vehicles 130 may comprise a first smart transport vehicle 131 controlled by the master control server and one or more second smart transport vehicles 132 controlled by the slave control servers. The smart transport vehicles 130 may comprise AGVs or AMRs. The smart transport vehicle 130 may comprise a driving unit, a sensing unit, a loading unit, a communication unit, a control unit, an/or other suitable units.

The driving unit may comprise a section that is configured to enable the smart transport vehicle 130 to physically move. The driving unit may comprise a motor, wheels, and a suspension. The driving unit may be configured to control the speed and orientation along the movement route of the smart transport vehicle 130, and support autonomous driving functions.

The sensing unit may comprise a section that is configured to collect data for the smart transport vehicle 130 to detect surrounding environments and recognize routes and obstacles. The sensing unit may comprise a laser sensor (e.g., LiDAR), an ultrasonic sensor, an infrared sensor, a camera, a vision system, and/or other suitable sensors or systems. The sensing unit may be configured to enable the smart transport vehicle 130 to recognize obstacles or objects in the route while driving, thereby driving safely.

The loading unit may comprise a section configured to enable the smart transport vehicle 130 to function to transport and load goods. The loading unit may comprise a pallet or a conveyor, and a lifting mechanism. The loading unit may be configured to enable the smart transport vehicle 130 to carry goods and load or unload goods accurately at the destination.

The communication unit may comprise a section configured to enable the exchange of information between the smart transport vehicle 130 and the control servers, and between the smart transport vehicle 130 and other smart transport vehicles 130. The communication unit may be configured to exchange data with a central control system through various communication technologies such as, e.g., Wi-Fi, 5G, and Bluetooth. The communication unit may be configured to enable communication between smart transport vehicles 130 so that smart transport vehicles 130 share information such as location and route in real time, thereby avoiding a collision. The communication unit may be configured to enable the smart transport vehicle 130 to receive one or more commands from the control server and transmit work status and driving information, thereby efficiently operating the entire system.

The control unit may comprise a section that is configured to control all operations of the smart transport vehicle 130, and analyze data collected from the sensing unit to determine how to drive and tasks. The control unit may be configured to serve as a brain of the AGV, and may comprise a main controller that is configured to comprehensively manage all functions, including driving, loading, and communication functions. The control unit may comprise a programmable logic controller (PLC) that is configured to control interactions with various kinds of equipment and control the smart transport vehicle 130 according to one or more commands. The control unit may be configured to control the route, speed, and task commands of the smart transport vehicle 130, in real time, and make an appropriate decision based on sensor data.

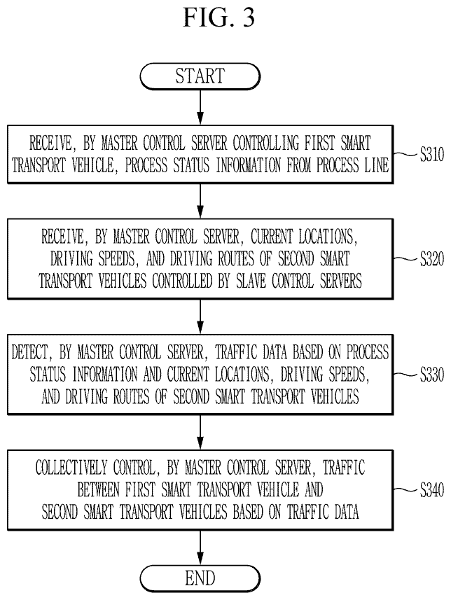

Referring now to FIG. 3, a flowchart of a split processing-based smart transport vehicle control method is illustratively depicted, according to an exemplary embodiment of the present disclosure. According to an exemplary embodiment, the split processing-based smart transport vehicle control method of FIG. 3 may be performed through the split processing-based smart transport vehicle control device 100 (see, e.g., FIG. 2).

In FIG. 3, the split processing-based smart transport vehicle control device 100 may be configured to receive process status information from a process line through a master control server controlling a first smart transport vehicle (step S310).

The split processing-based smart transport vehicle control device 100 may be configured to receive current locations, driving speeds, and driving routes of second smart transport vehicles controlled by slave control servers through the master control server (step S320).

The split processing-based smart transport vehicle control device 100 may be configured to detect traffic data based on the process status information and the current locations, driving speeds, and driving routes of the second smart transport vehicles through the master control server (step S330).

The split processing-based smart transport vehicle control device 100 may be configured to collectively control traffic between the first smart transport vehicle and the second smart transport vehicles based on the traffic data through the master control server (step S340).

According to an exemplary embodiment, the split processing-based smart transport vehicle control device 100 may be configured to set a traffic section based on the process status information through the master control server. The split processing-based smart transport vehicle control device 100 may be configured to detect traffic data of the first smart transport vehicle and the second smart transport vehicles in the set traffic section, and collectively control traffic based on the detected traffic data.

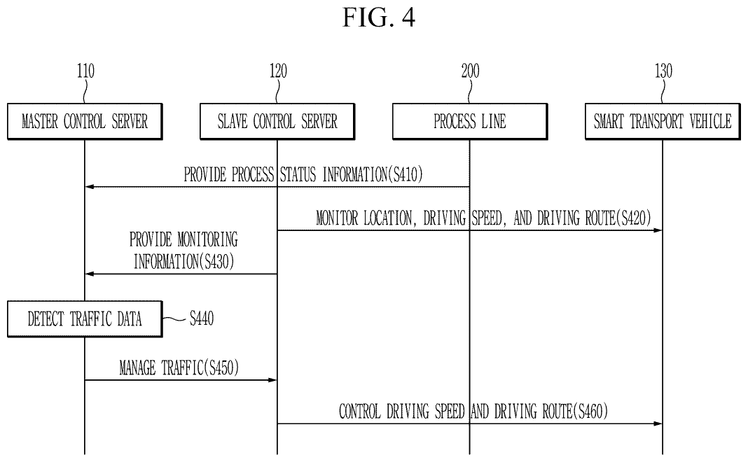

Referring now to FIG. 4, a signal flow diagram of the split processing-based smart transport vehicle control method is illustratively depicted, according to an exemplary embodiment of the present disclosure.

In FIG. 4, the master control server 110 may be configured to receive process status information from the process line 200 (step S410).

The slave control servers 120 may be configured to monitor locations, driving speeds, and driving routes of the smart transport vehicles 130 (step S420).

The slave control servers 120 may be configured to provide monitoring information about the smart transport vehicles 130 to the master control server 110 (step S430).

The master control server 110 may be configured to detect traffic data based on the process status information and the monitoring information (step S440).

The master control server 110 may be configured to transmit one or more commands necessary for traffic management to the slave control servers 120 based on the traffic data (step S450).

The slave control server 120 may be configured to command speed control, including a driving speed and a driving route, for each smart transport vehicle 130 (step S460).

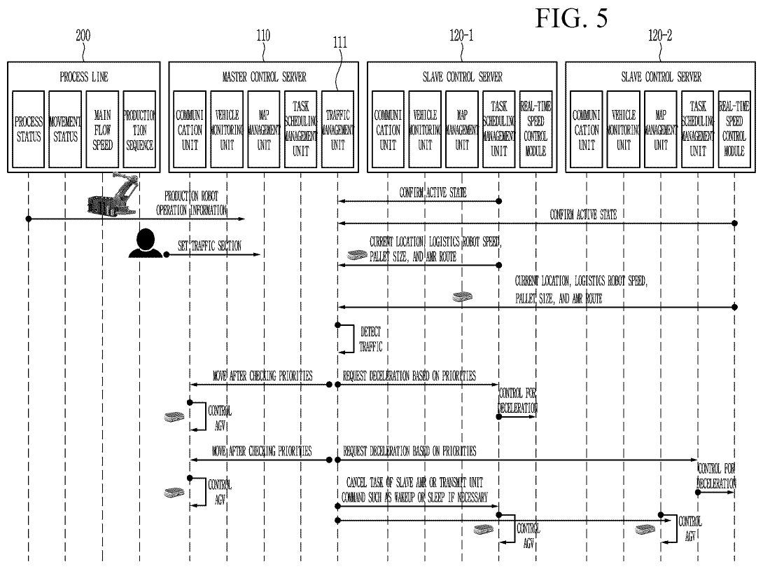

Referring now to FIG. 5, a signal flow diagram of the split processing-based smart transport vehicle control method is illustratively depicted, according to an exemplary embodiment of the present disclosure.

In FIG. 5, the process line 200 may be configured to provide process status including production robot operation information to the master control server 110.

The operator may be configured to set a traffic section through the master control server 110. The master control server 110 may be configured to confirm whether the slave control servers 120-1 and 120-2 are in an active state. Alternatively, the slave control servers 120-1 and 120-2 may be configured to confirm whether the master control server 110 is an active state.

When the master control server 110 or the slave control servers 120-1 and 120-2 are disconnected, the master control server 110 or the slave control servers 120-1 and 120-2 may be in an inactive state, and the master control server 110 or the slave control servers 120-1 and 120-2 in the inactive state may be excluded from the traffic management target.

The slave control servers 120-1 and 120-2 may be configured to monitor the smart transport vehicles assigned thereto, respectively, and transmit current locations, pallet sizes, driving speeds, and driving routes of the assigned smart transport vehicles to the traffic management unit 111 of the master control server 110.

The traffic management unit 111 may be configured to detect traffic data based on the process status information and the monitoring information about the smart transport vehicles.

The master control server 110 may be configured to detect one or more priorities between the first smart transport vehicle and the second smart transport vehicles based on the detected traffic data, and control the first smart transport vehicle and the second smart transport vehicles based on the priorities. That is, based on the one or more priorities, the master control server 110 may be configured to request the first smart transport vehicle or one of the second smart transport vehicles to accelerate, and request another one of the second smart transport vehicles to decelerate.

For example, the traffic management unit 111 may be configured to request the slave control servers 120-1 and 120-2 to decelerate according to the priorities. The slave control servers 120-1 and 120-2 may be configured to control the second smart transport vehicles to decelerate through the real-time speed control module.

The traffic management unit 111 may be configured to control the first smart transport vehicle to accelerate based on the priorities through the communication unit of the master control server 110. The traffic management unit 111 may be configured to command each of the second smart transport vehicles to stop, slow down, accelerate, or cancel a task, based on the current locations, driving speeds, and driving routes of the second smart transport vehicles, to avoid a collision between the second smart transport vehicles.

The traffic management unit 111 may be configured to collectively command the smart transport vehicles to operate in a power saving mode or wake up from the power saving mode. For example, the traffic management unit 111 may be configured to collectively transmit a unit command to cancel a task, sleep, or wake up to the smart transport vehicles through the slave control servers 120-1 and 120-2, if necessary.

The slave control servers 120-1 and 120-2 may be configured to perform task-related control on the smart transport vehicles through the task scheduling management unit when receiving a unit command.

According to an exemplary embodiment, the master control server 110 may be connected to a plurality of databases of the plurality of slave control servers 120-1 and 120-2 to acquire data about the smart transport vehicles in a black box manner from the plurality of databases.

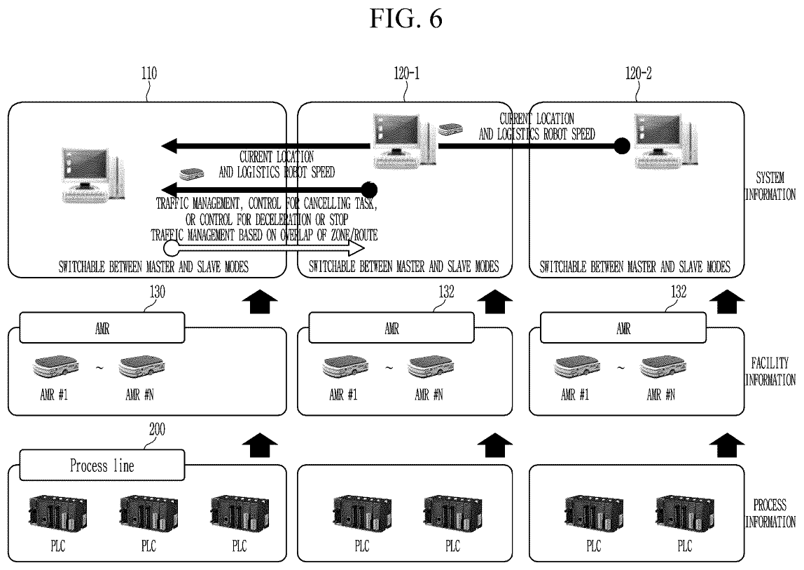

Referring now to FIG. 6, a diagram for explaining the split processing-based smart transport vehicle control device is illustratively depicted, according to an exemplary embodiment of the present disclosure.

In FIG. 6, the smart transport vehicles may be configured to be implemented by, for example, AMRs, and the process line may provide process information through a PLC.

The master control server 110 and each of the plurality of slave control servers 120-1 and 120-2 may be configured to switch between master and slave modes. The master control server 110 may be configured to receive process information from the process line 200 and facility information from the plurality of assigned AMRs.

The slave control servers 120-1 and 120-2 may be configured to receive facility information from the plurality of AMRs assigned thereto, respectively, and separately receive process information from the process line 200.

The master control server 110 may be configured to perform integrated control, such as, e.g., traffic management, control for cancelling a task of a smart transport vehicle, control for deceleration or stop, or traffic management based on zone/route overlap, with respect to the slave control servers 120-1 and 120-2.

Each of the slave control servers 120-1 and 120-2 may be configured to provide traffic data including current locations and speeds of the smart transport vehicles to the master control server 110.

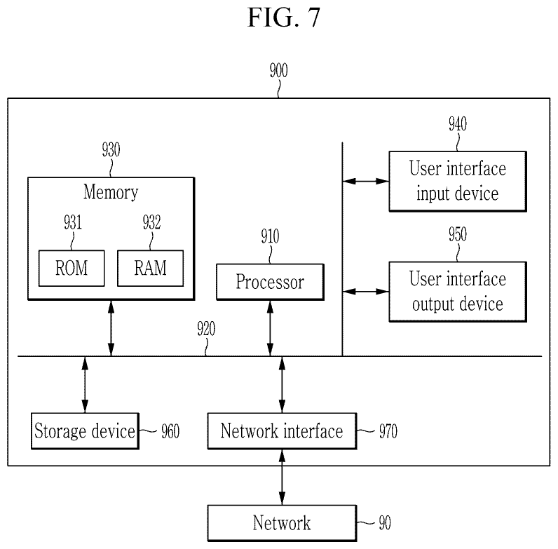

FIG. 7 is a diagram for explaining a computing device, according to an exemplary embodiment of the present disclosure.

Referring to FIG. 7, split processing-based smart transport vehicle control devices and methods, according to exemplary embodiments, may be implemented using a computing device 900.

The computing device 900 may comprise at least one of a processor 910, a memory 930, a user interface input device 940, a user interface output device 950, a storage device 960, which communicates with each other through a bus 920, and/or other suitable components. The computing device 900 may comprise a network interface 970 electrically connected to a network 90. The network interface 970 may be configured to transmit or receive signals to or from other entities via the network 90.

The processor 910 may be implemented in various types such as a micro controller unit (MCU), an application processor (AP), a central processing unit (CPU), a graphic processing unit (GPU), and a natural processing unit (NPU), and may be any semiconductor device that executes commands stored in the memory 930 or the storage device 960. The processor 910 may be configured to implement the above-described functions and methods described above with respect to FIGS. 1 to 6.

The memory 930 and the storage device 960 may comprise various types of volatile or non-volatile storage media. For example, the memory may comprise a read-only memory (ROM) 931 and a random access memory (RAM) 932. In the present exemplary embodiment, the memory 930 may be located inside or outside the processor 910, and the memory 930 may be connected to the processor 910 through various known means.

In some exemplary embodiments, at least some of the configurations or functions of the split processing-based smart transport vehicle control devices and methods according to the exemplary embodiments may be implemented by programs or software executed by the computing device 900, and the programs or software may be stored in a computer-readable medium.

In some exemplary embodiments, at least some of the configurations or functions of the split processing-based smart transport vehicle control devices and methods according to the exemplary embodiments according to the exemplary embodiments may be implemented using hardware or circuitry of the computing device 900, or may be implemented by separate hardware or circuitry that may be electrically connected to the computing device 900.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A split processing-based smart transport vehicle control device, comprising:
one or more smart transport vehicles configured to transport objects in an unmanned manner in an industrial system; and
one or more control servers configured to control the one or more smart transport vehicles,
wherein:
the one or more control servers comprise:
a master control server configured to control a first smart transport vehicle; and
one or more slave control servers configured to control second smart transport vehicles, and
the master control server is configured to collectively control traffic between the first smart transport vehicle and the one or more second smart transport vehicles.

2. The split processing-based smart transport vehicle control device of claim 1, wherein the one or more slave control servers are configured to:
monitor the one or more second smart transport vehicles assigned thereto, respectively, and
transmit current locations, driving speeds, and driving routes of the one or more second smart transport vehicles to the master control server.

3. The split processing-based smart transport vehicle control device of claim 2, wherein the master control server is configured to:
receive process status information including a process speed from a process line, and
set a traffic section based on the received process status information.

4. The split processing-based smart transport vehicle control device of claim 3, wherein the master control server comprises a traffic management unit configured to detect traffic data between the first smart transport vehicle and the one or more second smart transport vehicles based on the process status information, the traffic section, and the current locations, driving speeds, and driving routes of the one or more second smart transport vehicles.

5. The split processing-based smart transport vehicle control device of claim 4, wherein the traffic management unit is configured to:
detect one or more priorities between the first smart transport vehicle and the one or more second smart transport vehicles based on the detected traffic data, and
control the one or more smart transport vehicles based on the one or more priorities.

6. The split processing-based smart transport vehicle control device of claim 5, wherein the traffic management unit is configured to:
request the first smart transport vehicle or one of the one or more second smart transport vehicles to accelerate, and
request another one of the one or more second smart transport vehicles to decelerate based on the priorities.

7. The split processing-based smart transport vehicle control device of claim 4, wherein the traffic management unit is configured to command each of the one or more second smart transport vehicles to stop, slow down, accelerate, or cancel a task, based on the current locations, driving speeds, and driving routes of the second smart transport vehicles, to avoid a collision between the one or more second smart transport vehicles.

8. The split processing-based smart transport vehicle control device of claim 4, wherein the traffic management unit is configured to collectively command the one or more second smart transport vehicles to operate in a power saving mode or wake up from the power saving mode.

9. The split processing-based smart transport vehicle control device of claim 1, wherein the master control server is connected to a plurality of databases of the one or more slave control servers to acquire data about the second smart transport vehicles in a black box manner from the plurality of databases.

10. The split processing-based smart transport vehicle control device of claim 1, wherein:
the one or more smart transport vehicles comprise automated guided vehicles (AGVs) or autonomous mobile robots (AMRs), and
the one or more control servers comprise AGV/AMR control systems (ACSs).

11. A split processing-based smart transport vehicle control method, comprising:
receiving, by a master control server configured to control a first smart transport vehicle, process status information from a process line;
setting, by the master control server, a traffic section based on the process status information;
receiving, by the master control server, current locations, driving speeds, and driving routes of one or more second smart transport vehicles controlled by one or more slave control servers;
detecting, by the master control server, traffic data based on the process status information and the current locations, driving speeds, and driving routes of the one or more second smart transport vehicles; and
collectively controlling, by the master control server, traffic between the first smart transport vehicle and the one or more second smart transport vehicles based on the traffic data.

12. The split processing-based smart transport vehicle control method of claim 11, further comprising confirming, by the master control server, whether the one or more slave control servers are in an active state.

13. The split processing-based smart transport vehicle control method of claim 11, further comprising:
monitoring, by the slave control servers, the one or more second smart transport vehicles assigned thereto, respectively; and
transmitting the current locations, driving speeds, and driving routes of the one or more second smart transport vehicles to the master control server.

14. The split processing-based smart transport vehicle control method of claim 11, wherein the collectively controlling of the traffic between the first smart transport vehicle and the one or more second smart transport vehicles based on the traffic data by the master control server comprises:
detecting, by the master control server, one or more priorities between the first smart transport vehicle and the one or more second smart transport vehicles based on the traffic data; and
controlling the first smart transport vehicle and the one or more second smart transport vehicles based on the one or more priorities.

15. The split processing-based smart transport vehicle control method of claim 14, wherein:
the one or more second smart transport vehicles comprises a plurality of second transport vehicles, and
the controlling of the first smart transport vehicle and the one or more second smart transport vehicles based on the priorities by the master control server comprises:
requesting the first smart transport vehicle or one of the plurality of second smart transport vehicles to accelerate; and
requesting another one of the plurality of second smart transport vehicles to decelerate based on the priorities.

16. The split processing-based smart transport vehicle control method of claim 11, further comprising commanding, by the master control server, each of the one or more second smart transport vehicles to stop, slow down, accelerate, or cancel a task, based on the current locations, driving speeds, and driving routes of the second smart transport vehicles, to avoid a collision between the second smart transport vehicles.

17. The split processing-based smart transport vehicle control method of claim 11, wherein the collectively controlling of the traffic between the first smart transport vehicle and the one or more second smart transport vehicles based on the traffic data by the master control server comprises:
collectively commanding, by the master control server, the one or more second smart transport vehicles to operate in a power saving mode or wake up from the power saving mode.

18. The split processing-based smart transport vehicle control method of claim 11, further comprising:
connecting the master control server to a plurality of databases of the one or more slave control servers; and
acquiring data about the one or more second smart transport vehicles in a black box manner from the plurality of databases.

19. The split processing-based smart transport vehicle control method of claim 11, further comprising excluding a slave control server of which the active state is not confirmed, among the one or more slave control servers, from a traffic management target.

20. The split processing-based smart transport vehicle control method of claim 11, wherein:
the first smart transport vehicle and the one or more second smart transport vehicles comprise automated guided vehicles (AGVs) or autonomous mobile robots (AMRs), and
the master control server and the one or more slave control servers comprise AGV/AMR control systems (ACSs).
